(19) United States
(12) Patent Application Publication
(10) Pub. No.: US 2004/0001338 A1
(43) Pub. Date: Jan. 1, 2004

(54) Illuminating lamp and methods associated therewith

(76) Inventor: John Austin Pine, Denver, CO (US)

Correspondence Address: JOHN AUSTIN PINE, UNIT 6, 11354 WEST 13 TH. AVENUE, LAKEWOOD, CO, 80215, US

(21) Appl. No.: 10/184,732

(22) Filed: Jun. 27, 2002

(51) Int. Cl. F21L 19/00; F21V 35/00

(52) U.S. Cl. 362/161

(57) ABSTRACT

Disclosed herein is a lamp made from a substantially translucent material for producing light from a flame burning a combustible fluid.

### RELATED CASE

This application relates to a co-pending design patent application titled ‘ILLUMINATING LAMP DESIGN’ of the same inventor, John Austin Pine, filed on Jun. 27, 2002 via Express Mail Certificate Number ET780697750US, Ser. No. ______, which is hereby specifically incorporated by reference for all that is contained therein.

### BACKGROUND

One common method of generating light is by combusting a fluid in a lamp. There are a variety of lamps known in the art, each having unique characteristics. Some known devices have wicks that have one end surrounded by the combustible fluid, while an opposite end includes a combustion end. At the combustion end, the combustible fluid is ignited to generate a flame. The flame emits light that can be used to illuminate the lamp and objects located in the vicinity of the lamp.

### SUMMARY

In one exemplary embodiment, a lamp may include: a reservoir; a funnel/shade integrally formed adjoining the reservoir; a cover including a perimeter portion and a port formed there through, the cover being integrally formed adjoining the reservoir at the cover perimeter portion; and a wick providing fluid communication between the reservoir and the funnel/shade through the port.

In another exemplary embodiment, a method of generating light may include: providing a lamp including a reservoir and a funnel/shade integrally formed adjacent to and in fluid communication with the reservoir; dispensing a combustible liquid into the funnel/shade; transferring the combustible liquid from the funnel/shade to the reservoir; providing a wick including a combustion end and an oppositely disposed reservoir end, the reservoir end being placed into the combustible liquid contained in the reservoir; and igniting the combustible liquid located at the wick combustion end to generate the light.

In another exemplary embodiment, a method of making a lamp may include: gathering glass on a blowpipe; forming a bubble inside the glass; jacking down a portion of the glass, thereby creating a reservoir and a funnel/shade; and separating the lamp from the blowpipe.

### BRIEF DESCRIPTION OF THE DRAWING

Illustrative embodiments of an oil lamp composed of a transparent material are shown in Figures of the drawing in which:

FIG. 1 shows a perspective view of an oil lamp.

FIG. 2 shows a front elevation view of the oil lamp of FIG. 1 with a portion broken-away therefrom to shown internal components thereof.

FIG. 3 shows a side elevation view of the oil lamp of FIG. 1.

FIG. 4 shows a top plan view of the oil lamp of FIG. 1.

FIG. 5 shows a bottom plan view of the oil lamp of FIG. 1.

FIG. 6 shows a cross-sectional side view of the oil lamp taken across plane 6-6 in FIG. 5.

FIG. 7 shows an enlarged portion of the cross-sectional view of FIG. 6 illustrated by detail ‘7’ in FIG. 6.

FIG. 8 shows a perspective view of a sleeve that is part of a wick assembly.

FIG. 9 shows a side elevation view of the sleeve of FIG. 8.

FIG. 10 shows a perspective view of one embodiment of an oil lamp provided with a plurality of crimps.

FIG. 11 shows a bottom plan view of the oil lamp of FIG. 10 provided with the plurality of crimps.

FIG. 12 shows a top plan view of the oil lamp of FIG. 10 provided with the plurality of crimps.

FIG. 13 shows a perspective view of one embodiment of an oil lamp configured as a wall sconces provided with a plurality of crimps, an elongated reservoir and an attachment bracket.

FIG. 14 shows a side elevation view of the oil lamp configuration of FIG. 13 with the attachment bracket removed therefrom.

FIG. 15 shows a cross-sectional side view of the oil lamp configured as a wall sconce taken across plan 15-15 of in FIG. 13.

FIG. 16 shows a perspective view of one embodiment of an oil lamp configured as a stemmed pendent provided with a plurality of crimps, an elongated reservoir, a stem and a base.

FIG. 17 shows a side elevation view of the stemmed pendant oil lamp illustrated in FIG. 16.

FIG. 18 shows a side elevation view of a wick assembly provided with a restriction sleeve.

### DETAILED DESCRIPTION

As depicted in the figures of the drawing, the present lamp may take a variety of forms. Examples of these forms include, but are not limited to: free standing desk lamps, wall hanging sconces and stemmed pendants. Those skilled in the art will appreciate that a large number of variations exist and are limited only by the creativity of the designer. As such, the scope of this disclosure should not be construed as being limited to the exemplary embodiments illustrated in the figures; these exemplary embodiments are provided for illustrative purposes only.

In general terms, the lamp is manufactured from translucent material, such as glass. The lamp is provided with a funnel/shade that is integrally formed on a reservoir out of one single piece of material. A combustible fluid, such as lamp oil, is dispensed into the funnel/shade and flows into the reservoir through a port. After transferring the combustible fluid into the reservoir, a wick assembly that includes a wick and a sleeve may be positioned into the port. The wick is positioned in the port such that one end of the wick contacts the combustible fluid. This positioning results in an oppositely disposed end of the wick called a combustion end being positioned in the funnel/shade. The combustible fluid is transferred via capillary action from the reservoir to the wick combustion end through the wick. The combustible fluid located at the wick combustion end is ignited thereby providing light. This light radiates through the funnel/shade to illuminate the lamp and objects surrounding the lamp.

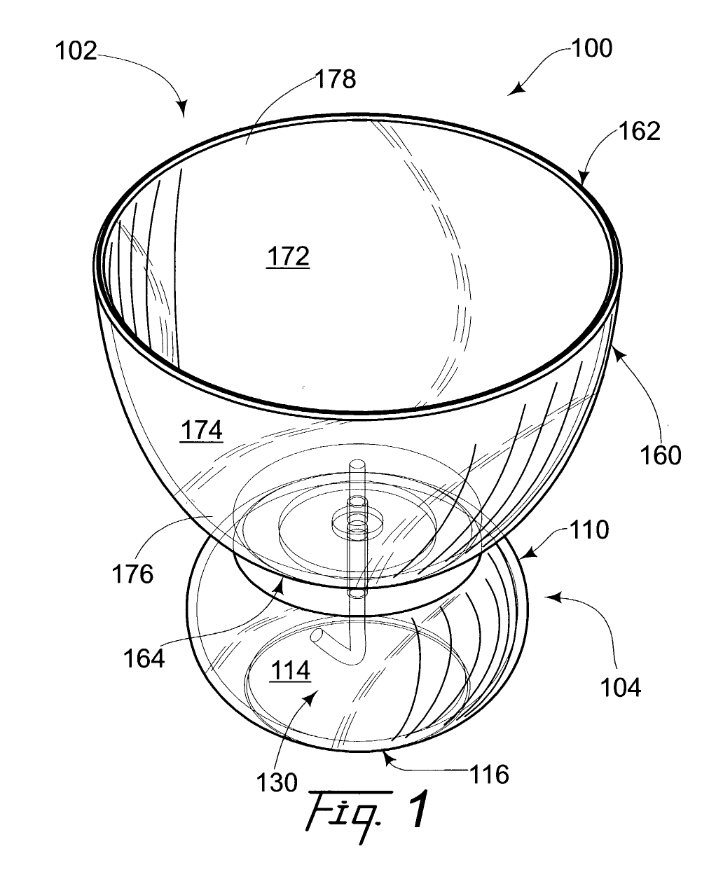

With reference to FIG. 1, one exemplary embodiment of a lamp 100 is shown. The lamp 100 generally defines a top portion 102 and an oppositely disposed bottom portion 104.

It is noted that terms such as ‘top’, ‘bottom’, ‘front’, ‘back’, ‘left’, ‘right’, ‘up’, ‘down’, ‘inside’, ‘outside’ and the like are used for illustrative purposes only. These terms ‘top’, ‘bottom’, etc. are relative to their environment are may be varied depending on the orientation of the objects to which they refer.

The lamp 100 is formed from a transparent or translucent material. In one exemplary embodiment, the main body of the lamp 100 may be made from one piece of glass. In one exemplary embodiment, the lamp 100 may be manufactured by ‘blowing’ the glass in a process that will be described in detail later herein.

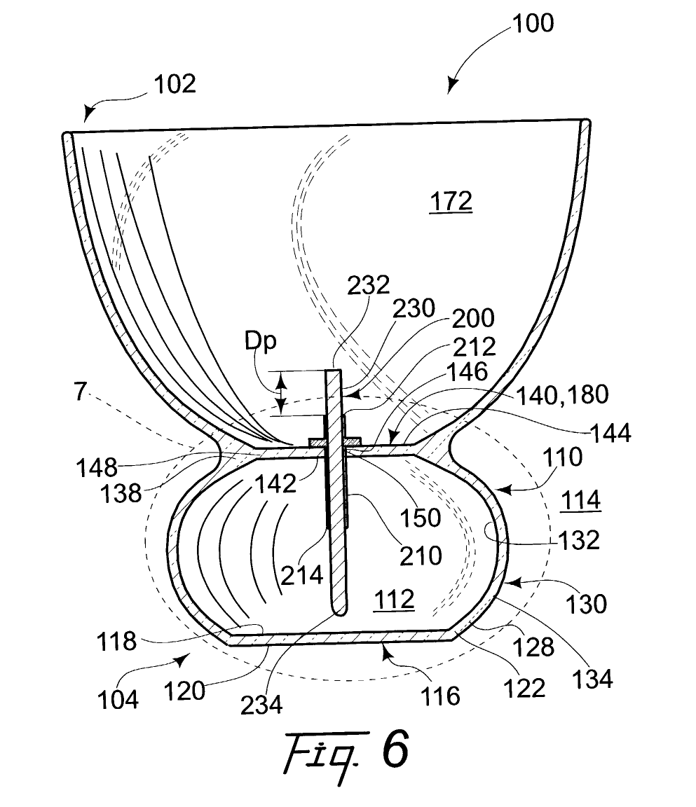

The lamp 100 may be provided with a reservoir 110, a funnel/shade 160 and a wick assembly 200 (FIG. 6). The reservoir 110 is located near the bottom portion 104 of the lamp, while the funnel/shade 160 is located near the top portion 102. The wick assembly 200 extends between the funnel/shade 160 and the reservoir 110 in a manner that will be described later herein.

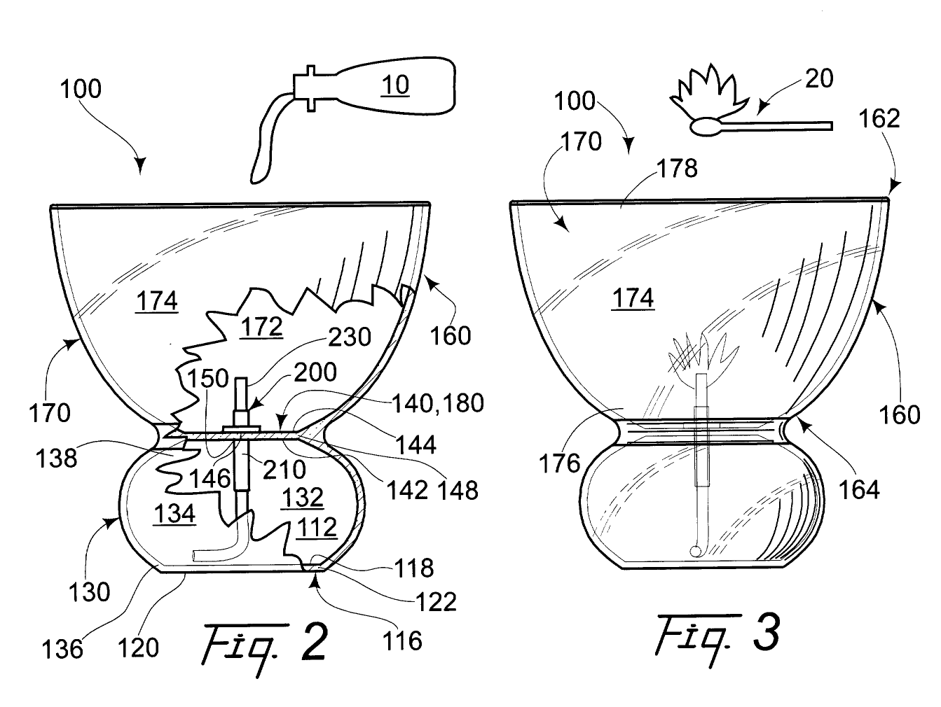

With reference to FIG. 1, the reservoir 110 may define an interior portion 112 (FIG. 2) and an exterior portion 114. The interior portion 112 may be separated from the exterior portion by various features of the reservoir 110. These various features of the reservoir 110 may include a base 116, a peripheral wall 130 and a cover 140 (FIG. 2).

With reference to FIG. 2, the base 116 defines an inside surface 118 and an oppositely disposed outside surface 120. The base 116 may also define a perimeter portion 122 that is oppositely disposed from the center of the base 116. The peripheral wall 130 defines an inside surface 132 and an oppositely disposed outside surface 134. The peripheral wall 130 also defines a base portion 136 and an oppositely disposed cover portion 138. The cover 140 defines and inside surface 142 and an oppositely disposed outside surface 144. The cover 140 also defines a center 146 and a perimeter portion 148. The cover 140 may be provided with a port 150 located at the center 146 that allows for fluid communication between the cover outside surface 144 and the cover inside surface 142.

With continued reference to FIG. 2, the reservoir 110 may be provided with the peripheral wall 130 that is integrally formed on the base 116. As used herein, the term ‘integrally formed’ may describe a manufacturing process that results in a virtually impenetrable seam, such as, for example, a seam created when one piece of molten glass is formed into the lamp 100. This forming of the peripheral wall 130 on the base 116 may result in the peripheral wall base portion 136 adjoining the base inside portion 118 at the perimeter portion 122. The reservoir 110 may be further provided with the cover 140 that is integrally formed on the peripheral wall cover portion 138. This configuration of the cover 140 on the peripheral wall 130 may result in the cover inside surface 142 adjoining the peripheral wall cover portion 138.

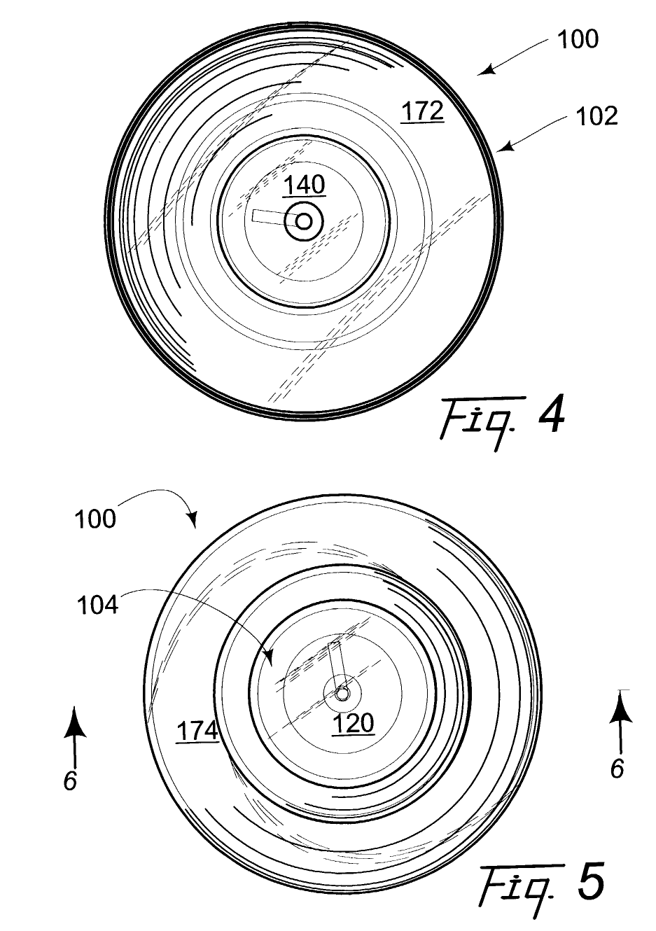

With reference to FIG. 3, the funnel/shade 160 may define a top portion 162 and an oppositely disposed bottom portion 164. The funnel/shade 160 may be provided with a peripheral wall 170 and a bottom 180 (FIG. 2). The peripheral wall 170 may define an inside portion 172 (FIG. 2) and an outside portion 174. As illustrated in FIGS. 1-6, the funnel/shade peripheral wall 170 may take the form of a ‘bowl’, although the shape may take other forms such as, for example, those illustrated in other figures of the drawing. The funnel/shade peripheral wall 170 may also define a bottom portion 176 and an oppositely disposed edge portion 178. As illustrated in FIGS. 2 and 6, the funnel/shade bottom 180 and the reservoir cover 140 may be the same element because they are fused together. The peripheral wall 170 may be integrally formed on the reservoir cover 140 (which is also the funnel/shade bottom 180) at the cover perimeter 148 on the cover outside portion 144. As described later herein, the funnel/shade 160 shields a flame from physical contact with nearby items and also from wind that may extinguish the flame. The funnel/shade 160 also improves dispensing of the combustible fluid into the lamp 100.

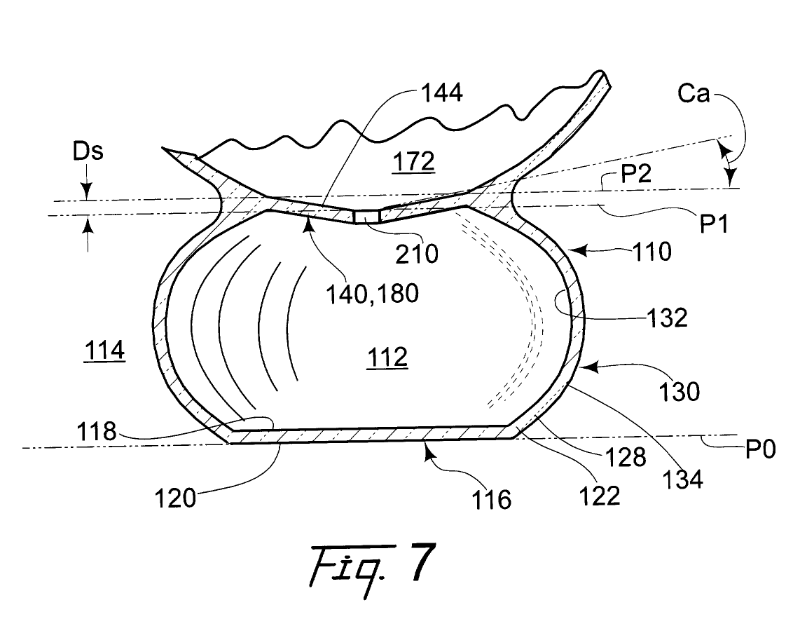

As illustrated in FIG. 7, the reservoir cover 140 (which is also the funnel/shade bottom 180) may be formed with a conical shape (i.e. the reservoir cover 140 may be slightly inclined). This conical shape of the reservoir cover 140 may be defined by providing a reference plane P0, a first plane P1 and a second plane P2. The reference plane P0 substantially adjoins the reservoir bottom 116, and the first plane P1 and the second plane P2 are substantially parallel to the reference plane P0. Additionally, the first plane P1 may reside between the second plane P2 and the reference plane P0. The first plane P1 is located at the intersection of the port 150 and the reservoir cover outside surface 144. The second plane P2 is located at the intersection of cover outside surface 144 and the funnel/shade inside portion 172; the second plane P2 is offset from the first plane P1 by a separation distance ‘Ds’. In one exemplary embodiment, this separation distance Ds may be at least 0.001 inches, for example Ds may be about 0.03 inches.

With continued reference to FIG. 7, the reservoir cover 140 may take a conical form having an inclination angle denoted by ‘Ca’. The inclination angle Ca may be any angle greater than zero, such as 1 degree. By providing the reservoir cover 140 in a conical form, the dispensing of combustible fluid from the funnel/shade 160 to the reservoir 110 via the port 150 is improved (as will be described later herein).

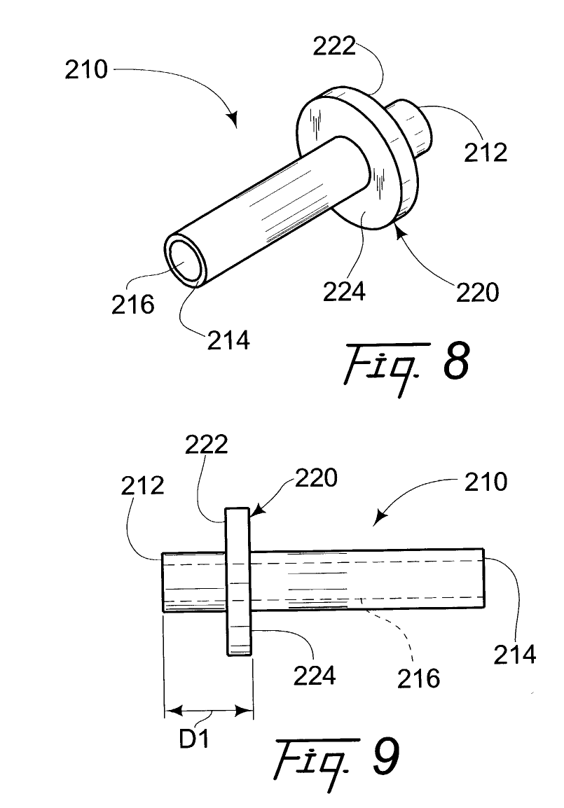

With reference to FIG. 6, the wick assembly 200 may be provided with a sleeve 210 and a wick 230. With reference to FIGS. 8 and 9, the sleeve 210 may define a first end 212 and an oppositely disposed second end 214. The sleeve 210 may be provided with a hole 216 that extends from the first end 212 to the second end 214. A shoulder 220 may be formed on the sleeve 210. The shoulder 220 may define a first surface 222 and an oppositely disposed second surface 224. The shoulder second surface 224 may be located at a first distance from the first end 212, the first distance is denoted in FIG. 9 as ‘D1’. In one exemplary embodiment, the first distance D1 is at least 0.5 inches. It has been determined that this exemplary first distance D1 ensures that fresh air is supplied to the flame, while also keeping the flame at a substantial distance from the cover 140. It should be noted that the sleeve 210 can be composed of any type of material capable of withstanding the temperature of the flame and the composition of the combustible fluid. Examples of the composition of the sleeve 210 include, but are not limited to: glass, brass, aluminum, steel, ceramic, aggregate, porcelain, etc. In one exemplary embodiment, the sleeve 210 is composed of glass.

With continued reference to FIG. 6, the wick 230 may be provided with a combustion end 232 and an oppositely disposed reservoir end 234. The wick 230 may be composed of any type of material capable of transferring fluid from one end to the other end. The wick 230 may take the form of a bundle of fibers, loosely twisted fibers, braided fibers, woven cord, tape, a tube of soft spun threads, or other material capable of drawing combustible fluid from the reservoir 110 to a flame (e.g. by capillary action). In one exemplary embodiment, a braided fiberglass wick 230 having a diameter of about 0.17 inches has been used. The use of a fiberglass-type wick 230 may be beneficial because the fiberglass does not melt if the combustible fluid is depleted. As illustrated in FIG. 6, the wick 230 is held in the sleeve hole 216 (FIG. 8) by frictional forces such that the wick combustion end 232 is located at a wick protrusion distance ‘Dp’ from the sleeve first end 212. In one exemplary embodiment, the wick protrusion distance Dp may be about 0.05 inches.

As illustrated best in FIG. 6, the wick assembly 200 may be positioned in the port 150 such that the wick reservoir end 234 is located in the reservoir 110, and the combustion end 232 is located in the funnel/shade 160.

In a process to be described later herein, the lamp 100 combusts a fluid that is referred to herein as combustible fluid. Although this combustible fluid may be any one of a variety of compositions, it is commonly referred to as ‘lamp oil’. Lamp oil is readily available at a variety of retail locations, such as grocery stores. One commercially available type of lamp oil is manufactured by LAMPLIGHT FARMS® of Menomonee Falls, Wis. under the brand name of ULTRA-PURE®. The ULTRA-PURE® lamp oil is a 99 percent pure liquid wax paraffin that burns without creating odors or smoke. Other types of combustible fluid may be used such as, kerosene, scented oils, colored oils, etc. For almost all applications, the above referenced lamp oil is preferred because it burns clean without any soot and burns when fresh air is limited in quantity.

Having provided a description of one exemplary embodiment of the present lamp, a description of the utilization thereof will now be provided. This description will include the dispensing of the combustible fluid into the lamp 100, the installation of the wick assembly 200 and the igniting of the lamp 100.

With reference to FIG. 2, at the outset, combustible fluid may be contained within a storage bottle 10. With the wick assembly 200 removed from the lamp 100, the combustible fluid may be dispensed from the storage bottle 10 into the funnel/shade 160 portion of the lamp 100. Since the funnel/shade 110 may take the form of a ‘cup’ the combustible fluid may temporarily collect therein. The combustible fluid collected in the funnel/shade 160 may be temporarily contained by the peripheral wall 170 and the cover 140 (also referred to as the funnel/shade bottom 180). This containment of the combustible fluid results in the funnel/shade inside portion 172 and the cover outside portion 144 contacting the combustible fluid.

As the combustible fluid is being dispensed from the storage bottle 10, the combustible fluid begins to transfer from the funnel/shade 160 to the reservoir 110. As previously described, the port 150 is located in the cover 140 at the bottom of the funnel/shade 160. As sometimes referred to herein as ‘fluid communication’, the port 150 provides passage between from the funnel/shade 160 to the reservoir 110. In one exemplary embodiment previously described and illustrated in FIG. 7, the cover outside surface 144 is inclined to provide a slightly conical form to the cover 140. The conical cover 140 allows the combustible fluid to flow directly into the reservoir without collecting on/in any part of the funnel/shade 160 (assuming that the reservoir 110 is not full).

Once the reservoir has been sufficiently ‘filled’, the storage bottle 10 (FIG. 2) may be tilted to terminate dispensing of the combustible fluid. After terminating the dispensing, the wick assembly 200 may be installed into the lamp 100. Before installing the wick assembly 200, it is beneficial to check that only a small portion of the combustion end 232 of the wick 230 extends past the sleeve first surface 212 (as previously mentioned, this wick protrusion distance Dp may be about 0.05 inches in one exemplary embodiment).

With reference to FIG. 6, to install the wick assembly 200 into the lamp 100, the wick reservoir end 234 may be positioned into and advanced through the port 150. As the wick 230 is advanced into the port 150, it passes into the reservoir interior portion 112. Since the combustible fluid is contained within the reservoir interior portion 112, the wick 230 contacts and is surrounded by the combustible fluid. After a certain amount of advancement of the wick 230 into the port 150, the sleeve second end 214 approaches the first plane P1 (FIG. 7). As the sleeve second end 214 advances past the second plane P2 and the first plane P1, the sleeve 210 enters the port 150. The sleeve 210 is advanced into the port 150 until the shoulder 220 contacts the cover 140. This contact results in the sleeve second surface 224 (FIG. 8) adjoining the cover outside surface 144. After the shoulder 220 contacts the cover 140, the combustion end 232 of the wick 230 is located at the first distance D1 (FIG. 9) plus the wick protrusion distance Dp from the cover 140.

After installing the wick assembly 200 into the lamp 100, the combustible fluid travels from the reservoir 110 to the wick combustion end 232 via capillary action. This capillary action occurs though the surface tension of the combustible fluid and the configuration of the fibers of the wick 230.

After a sufficient amount of time passes (which may be almost instantaneously), combustible fluid will be ‘available’ for combustion at the wick combustion end 232. Once a sufficient amount of combustible fluid is located at the wick combustion end 232, the fluid located at the wick combustion end 232 may be ignited. Ignition of the combustible fluid may occur transferring a flame from a lit object 20 to the wick 230. Examples of the lit object include, a match (as shown in FIG. 3), a lighter, and other obvious sources of fire.

After the combustible fluid located at the wick combustion end 232 is ignited, the resulting flame illuminates the lamp 100 and objects that are located close to the lamp 100. When the flame is burning in the lamp 100, the entire lamp 100 glows. When the lamp 100 is made from a colorful glass, this glowing is aesthetically pleasing and also sheds ambient light. This illumination of the lamp 100 may continue so long as the supply of combustible fluid from the reservoir continues to exist.

Once the reservoir 110 is depleted of combustible fluid, the flame located at the wick combustion end 232 dies. After a sufficient amount of time passes, the wick assembly 200 is cool enough to allow the user to remove the wick assembly 200 and replenish the combustible fluid. It should be noted that the user may simply ‘blow out’ the flame located at the wick combustion end 232 in order to extinguish the flame.

The lamp previously described may be manufactured from any one of a variety of materials such as plastic, wood, glass, aggregate, resin, etc. In one exemplary embodiment, the lamp is made from blown glass. The method of making a blown glass variety of lamp will be described herein. It should be noted that this description is provided for illustrative purposes only and other processes may be employed depending on the composition of the lamp and/or the quantities to be manufactured.

When manufactured by blowing glass, the lamp may be composed of a common mixture of silicates. At the outset, a glassblower gathers a quantity of molten glass on an end of a hollow blowpipe from a crucible located in a furnace. This molten glass is centered on the blowpipe and formed into a suitable shape by rolling it on a marver (a marver is a metal table on which glass is rolled in order to shape and cool the glass). If the quantity of molten glass is not sufficient for the particular lamp being blown, the glassblower may overlay an additionally quantity of glass on the first quantity.

Once a sufficient amount of glass has been gathered on the blowpipe, a small amount of air is blown into the hollow blowpipe. In a manner well know to those skilled in the art, a bubble of air is formed inside the molten glass by blowing air into the hollow blowpipe. The molten glass is worked in progressive steps to create a hollow ‘sphere’ of molten glass. In order to work the glass into this hollow sphere, the molten glass may be slightly reheated in a glory hole (commonly a gas-fired furnace) to soften the molten glass. Additionally, if the hollow sphere of molten glass is to be ‘flattened’ along its circumference, it may be rolled on the marver.

After forming the hollow sphere of molten glass, the glassblower sits at a bench and begins to work the molten glass by rolling the blowpipe along a pair of rails. As the glass is rotating, the glassblower may form the glass with newspaper, wood, metal, or other tools commonly found in glassblowing studios. The next step in forming the lamp is to create a separation point near the end of the blowpipe. A separation point is created by any one of a variety of techniques, such as ‘jacking down’ (i.e. reducing the thickness of) the glass near the blowpipe. A tool referred to in the art as jacks (which resemble a pair of blunt scissors) may be used to reduce the thickness of the glass.

After creating this separation point, the glassblower may partially collapse the hollow sphere of glass at a free end (the free end is opposite of the end attached to the blowpipe). By collapsing the molten glass near the free end, the hollow sphere is formed into the reservoir 110 and the adjacent funnel/shade 160. The point where the collapsing occurs is the location of the reservoir cover 140 and the funnel/shade bottom 180. When collapsing the hollow sphere, the reservoir cover 140 and the funnel/shade bottom 180 become fused together (it is noted that this fused combination is referred to herein as the reservoir cover 140). This fusing increases the strength and durability of the lamp by providing a robust internal feature. The action of collapsing is performed by squeezing the jacks until the port 150 is formed. It is important to note that the collapsing of the hollow sphere of glass terminates once the port 150 is formed with a suitable diameter. The suitable diameter of the port 150 allows the wick assembly 200 to be placed therein and also allows for fluid communication there through.

After collapsing the hollow sphere of molten glass to form the reservoir 110 and the funnel/shade 160, the glassblower may smooth the transition between the reservoir 110 and the funnel/shade 160. Smoothing the transition may be accomplished by rotating the blowpipe and pressing a forming object against the molten glass. Additionally, this smoothing also ensures that the funnel/shade bottom 116 is thoroughly fused to the reservoir cover 140. At this point in the blowing process, the reservoir bottom 116 may be ‘flattened’ by, for example, pressing a substantially flat piece of wood against the bottom 116.

Once the reservoir 110 and the funnel/shade 160 take a suitable form, they are removed from the primary blowpipe onto a punting pipe. The punting pipe is a second pipe that has a small quantity of molten glass on one end thereof. The molten glass on the punting pipe is used to temporarily attach the lamp to the punting pipe in order finish working the lamp. The end of the punting pipe having the molten glass is adjoined to and centered on the reservoir bottom 116.

Once a sufficient bond exists between the punting pipe and the lamp, the glassblower separates the lamp from the blowpipe. This separation occurs at the separation point formed in a previous step. The action of separating the lamp from the blowpipe may occur through any one of a variety of techniques employed in the art such as, but not limited to, a succinct exact impact, thermal shock (by dropping water on the separation point), or other know methods.

Having separated the lamp from the blowpipe, the lamp may require reheating in order to complete the manufacturing process. By introducing the lamp to the glory hole, the lamp is reheated to allow for the funnel/shade 160 to be finished. The funnel/shade 160 may be finished by ‘opening’ the peripheral wall 170. The process of opening the peripheral wall 170 may occur while the punting pipe is rotated on the pair of rails by moving the glass in a radially ‘outward’ direction. After the majority of the steps are completed, the conical cover 140 may be formed by pushing on the cover 140 at the center portion 146. Additionally, the diameter of the port 150 may be checked and modified if required.

Once the shape of the funnel/shade 160 is acceptable, the appearance of the lamp may be modified. One process for modifying the appearance of the lamp may be accomplished by spraying metal oxides onto the surface thereof and subsequently heating the lamp to fuse the oxides thereto. Other appearance modification can be employed, as those skilled in the art will appreciate.

After the lamp 100 is completely formed, the last step is to separate the lamp 100 from the punting pipe. This separation from the punting pipe occurs in an annealing oven by simply disrupting the bond between the glass located on the punting pipe and the lamp reservoir bottom 116. Once the lamp 100 is located in the annealing furnace, it is soaked at a soak temperature for a duration of time (e.g. 4 hours). After the lamp 100 has been thoroughly soaked, the temperature may be reduced over a period of time to bring it to room temperature. The annealing process minimizes the thermal shock to the glass that can cause breakage due to rapid or uneven cooling.

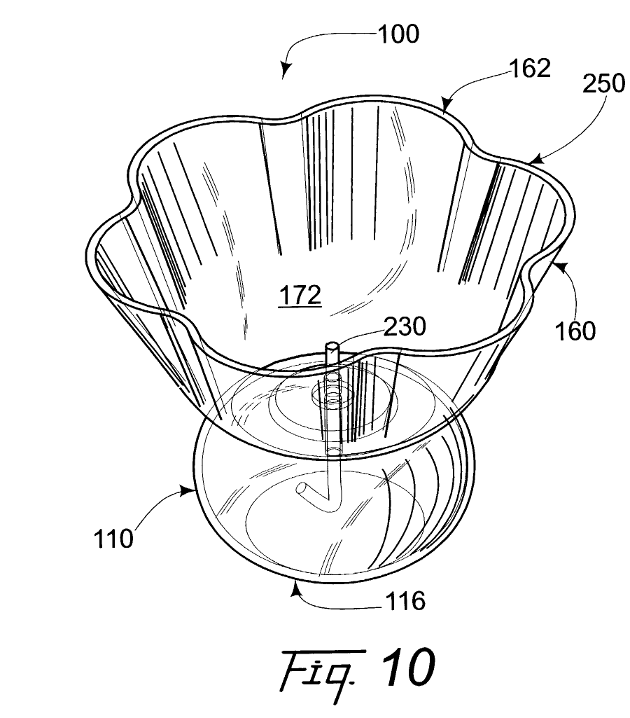

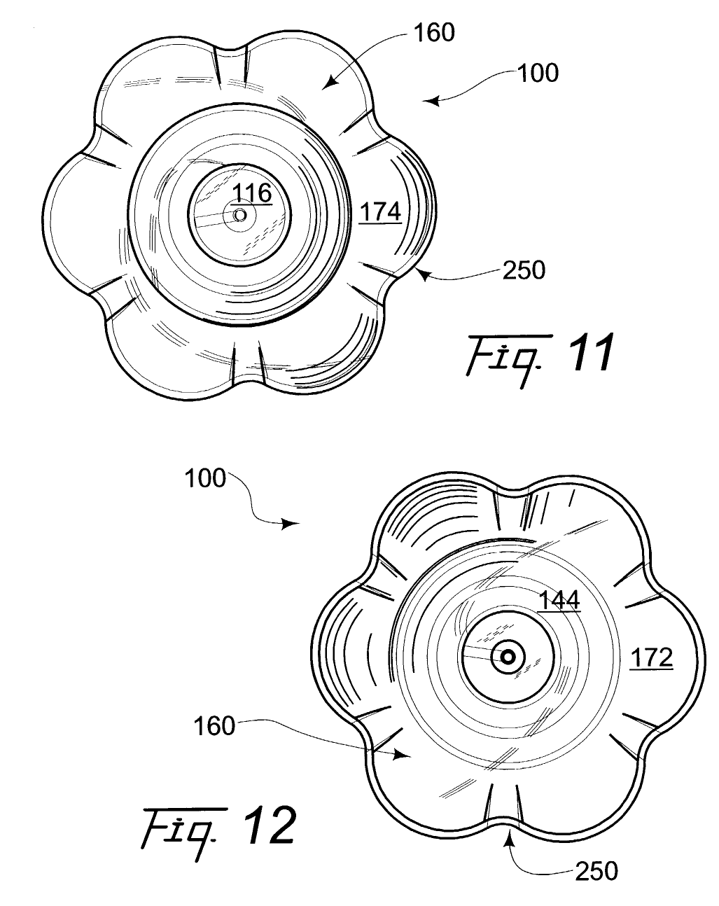

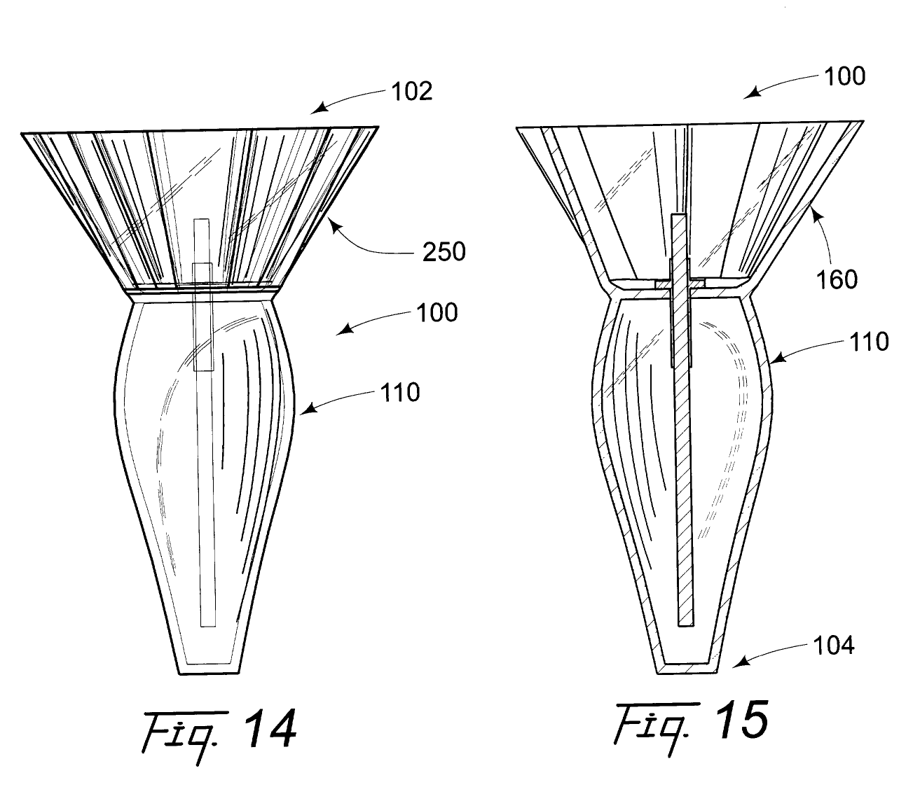

In one alternative embodiment illustrated in FIGS. 10-17, the funnel/shade 160 may be provided with a plurality of crimps 250. These plurality of crimps 250 may be formed in the funnel/shade top portion 162. One exemplary process for forming these crimps 250 is to place the funnel/shade 160 over a mandrel while it is still in a malleable state.

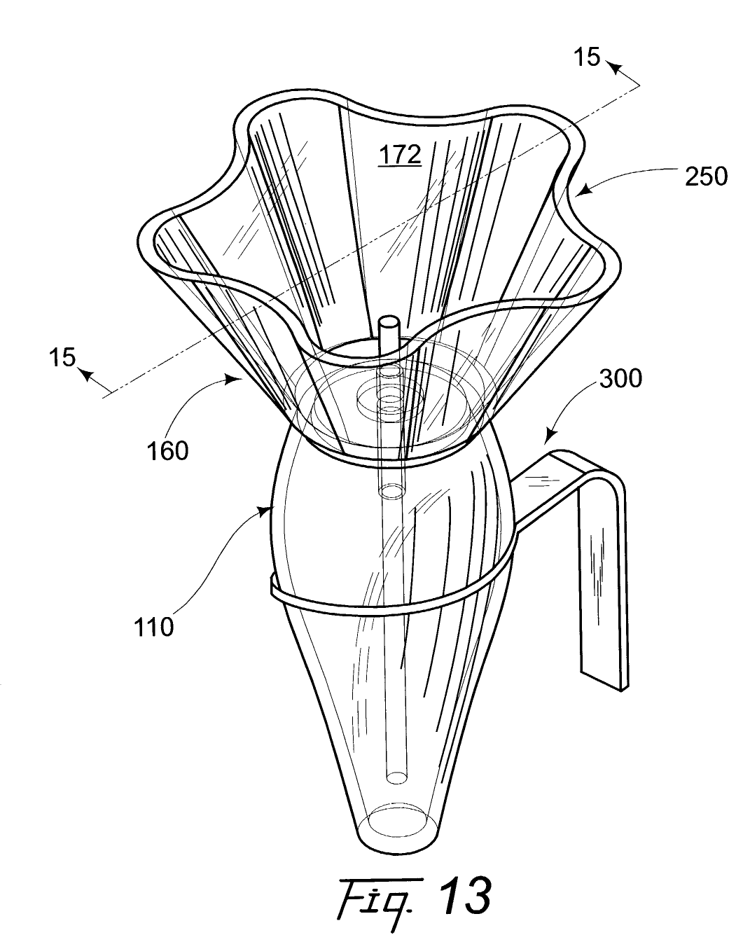

In another alternative embodiment illustrated in FIGS. 13-15, the lamp 100 may take the form of a wall sconce. When taking the form of a wall sconce, the lamp 100 may be provided with an attachment bracket 300. The attachment bracket 300 may be attached to a wall (not shown) and support the lamp 100 adjacent to the wall.

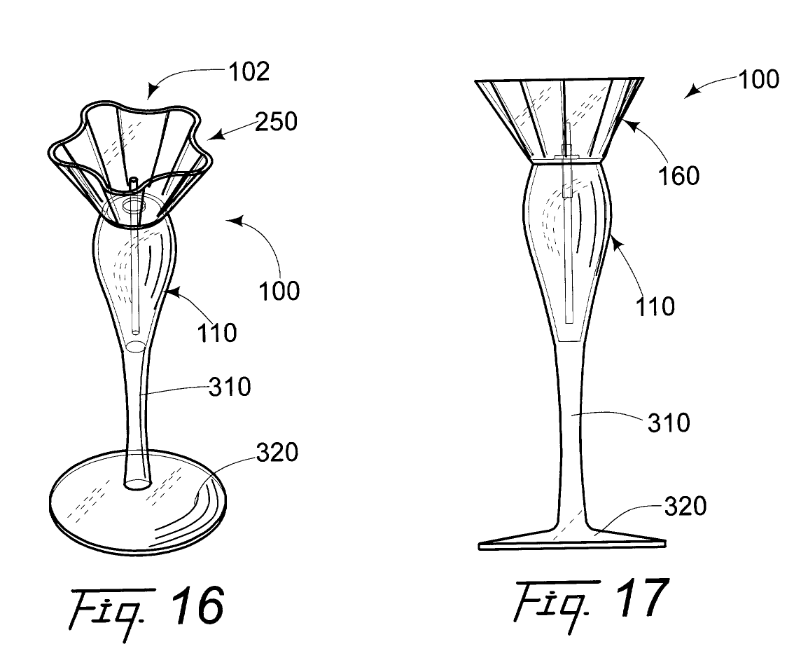

In another alternative embodiment illustrated in FIGS. 16 and 17, the lamp 100 may take the form of a stemmed pendant. In this alternative embodiment, a stem 310 may be formed on the reservoir bottom outside surface 120. Additionally, a base 320 may be formed on the stem 310 as illustrated in the figures.

In another alternative embodiment, the lamp 100 may be manufactured in a mechanized process. This mechanized process may include an extrusion process wherein a tube of molten glass is sequentially processed for creating lamps in a continuous process. A series of crimping and forming processes may be provided to complete tasks substantially similar to the tasks described for the manual production of lamp 100.

In another alternative embodiment, the lamp 100 may be colored by using frit, powdered glass, or overlay. This colorization of the lamp 100 may occur at any time during the process of manufacturing, for example before blowing the molten glass into a hollow sphere. Frit is a term used in the art to describe chips or chunks of colored glass. Powder is a term used in the art to describe small particles of colored glass. Overlay is a term used in the art to describe a layer of colored glass gathered on top of, in-between, or underneath a somewhat translucent carrier layer.

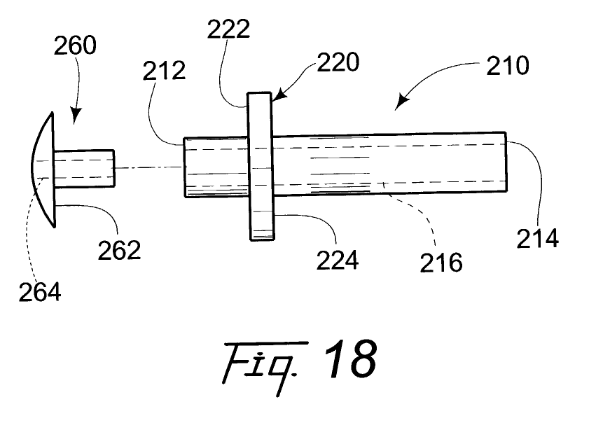

In another alternative embodiment illustrated in FIG. 18, the wick assembly 200 may be provided with a restriction sleeve 260. The restriction sleeve 260 may be provided with a shoulder 262 and a hole 264 formed there through. The wick 230 may be positioned into the restriction sleeve hole 264. The restriction sleeve 260 may limit the rate at which combustible fluid is transferred from the reservoir 110 to the wick combustion end 232. In one exemplary embodiment, the restriction sleeve 260 may be made from aluminum, although any heat resistance material may be used.

In another alternative embodiment, the lamp 100 may be provided with a funnel/shade 160 that ‘opens up’. As used herein, the term ‘opens up’ is defined as being configured such that the peripheral wall 170 increases in cross-section (wherein the portion near the cover 140 has a smaller cross-section than the portion near the lamp top portion 102).

While illustrative and presently preferred embodiments have been described in detail herein, it is to be understood that the concepts may be otherwise variously embodied and employed and that the appended claims are intended to be construed to include such variations except insofar as limited by the prior art.

I claim:

1. A lamp comprising:
a reservoir;
a funnel/shade integrally formed adjoining said reservoir;
a cover comprising a perimeter portion and a port formed there through, said cover being integrally formed adjoining said reservoir at said cover perimeter portion; and
a wick providing fluid communication between said reservoir and said funnel/shade through said port.

2. The lamp of claim 1 wherein said cover perimeter portion resides on a first plane and said cover port resides on a second plane that is different than said first plane.

3. The lamp of claim 1 and further comprising:
a sleeve comprising an external surface;
a hole formed through said sleeve;
wherein said wick is adjacent to said sleeve hole; and
wherein said sleeve external surface is adjacent to said port.

4. The lamp of claim 1 wherein said lamp is composed of a translucent material.

5. The lamp of claim 1 wherein said wick comprises a combustion end and an oppositely disposed reservoir end; wherein:
said combustion end extends beyond said sleeve,
said combustion end resides adjacent to said funnel/shade, and
said reservoir end resides adjacent to said reservoir.

6. The lamp of claim 1 wherein said funnel/shade comprises a peripheral wall formed transverse to said cover.

7. The lamp of claim 6 wherein said funnel/shade peripheral wall extends beyond said wick combustion end.

8. The lamp of claim 6 wherein:
said funnel/shade peripheral wall defines a first cross-sectional area and an oppositely disposed second cross-sectional area,
said first cross-sectional area being located adjacent to said cover; and
said second cross-sectional area is larger than said first cross-sectional area.

9. The lamp of claim 1 and further comprising a stem integrally formed on said reservoir.

10. The lamp of claim 9 and further comprising a base integrally formed on said stem.

11. The lamp of claim 6 wherein said funnel/shade peripheral wall comprises a plurality of crimps.

12. The lamp of claim 3 wherein said sleeve further comprises a shoulder located at least 0.3 inches away from an end of said sleeve.

13. A method of generating light comprising:
providing a lamp comprising a reservoir and a funnel/shade integrally formed adjacent to and in fluid communication with said reservoir;
dispensing a combustible liquid into said funnel/shade;
transferring said combustible liquid from said funnel/shade to said reservoir;
providing a wick comprising a combustion end and an oppositely disposed reservoir end, said reservoir end being placed into said combustible liquid contained in said reservoir; and
igniting said combustible liquid located at said wick combustion end to generate said light.

14. The method of claim 13 wherein:
said providing said lamp comprises providing a port through which said fluid communication occurs;
said transferring occurs through said port; and
said providing dais wick comprises positioning said wick into said port.

15. A method of making a lamp comprising:
gathering glass on a blowpipe;
forming a bubble inside said glass;
jacking down a portion of said glass, thereby creating a reservoir and a funnel/shade; and
separating said lamp from said blowpipe.

16. The method of claim 15 and further comprising:
forming a port enabling fluid communication between said reservoir and said funnel/shade.

17. The method of claim 15 and further comprising integrally forming a stem on said reservoir.

18. The method of claim 15 and further comprising forming a plurality of crimps in said funnel/shade.
